(19) United States
(12) Patent Application Publication
(10) Pub. No.: US 2016/0282770 A1
(43) Pub. Date: Sep. 29, 2016

(54) MEANDER CONTROL MEMBER, TRANSFER BELT, TRANSFER UNIT, AND IMAGE-FORMING APPARATUS

(71) Applicant: FUJI XEROX CO., LTD., Tokyo (JP)

(72) Inventors: Masayuki SEKO, Kanagawa (JP); Hiromoto YAMAKI, Kanagawa (JP)

(73) Assignee: FUJI XEROX CO., LTD., Tokyo (JP)

(21) Appl. No.: 14/831,264

(22) Filed: Aug. 20, 2015

(30) Foreign Application Priority Data
Mar. 25, 2015 (JP) 2015-062908

(51) Int. Cl. G03G 15/16; B65G 15/46

(52) U.S. Cl. CPC G03G 15/1615; B65G 15/46

(57) ABSTRACT

A meander control member includes a bonding surface to be bonded to an endless belt substrate and a longitudinally extending region other than the bonding surface. The longitudinally extending region contains a polyester elastomer and has a friction coefficient of about 0.5 to about 0.7.

### CROSS-REFERENCE TO RELATED APPLICATIONS

This application is based on and claims priority under 35 USC 119 from Japanese Patent Application No. 2015-062908 filed Mar. 25, 2015.

### BACKGROUND

(i) Technical Field

The present invention relates to meander control members, transfer belts, transfer units, and image-forming apparatuses.

(ii) Related Art

In electrophotographic image-forming apparatuses, an electrostatic latent image is formed on a charged surface of an electrophotographic photoreceptor, for example, with a laser beam modulated with an image signal. The electrostatic latent image is then made visible by development with charged toner to form a toner image. The toner image is electrostatically transferred to a recording medium such as paper and is fixed with heat and pressure.

Color image-forming apparatuses include multiple image-forming units that form toner images of different colors. The toner images formed by the image-forming units are sequentially transferred, for example, to an intermediate transfer belt such that they are superimposed on top of each other. The superimposed toner image is then transferred from the intermediate transfer belt to a recording medium.

Monochrome image-forming apparatuses are classified into those that directly transfer a toner image from a surface of an electrophotographic photoreceptor to a recording medium and those that transfer a toner image from a surface of an electrophotographic photoreceptor to a transfer belt and then to a recording medium.

In image-forming apparatuses that transfer a toner image to a recording medium via a transfer belt, the transfer belt is supported by multiple rollers and rotates circumferentially. There are proposed various approaches to prevent the transfer belt from meandering in the axial direction of the support rollers.

### SUMMARY

According to an aspect of the invention, there is provided a meander control member including a bonding surface to be bonded to an endless belt substrate and a longitudinally extending region other than the bonding surface. The longitudinally extending region contains a polyester elastomer and has a friction coefficient of about 0.5 to about 0.7.

### BRIEF DESCRIPTION OF THE DRAWINGS

Exemplary embodiments of the present invention will be described in detail based on the following figures, wherein:

FIG. 1 is a schematic view of an example meander control member according to an exemplary embodiment;

FIG. 2 is a partially cutaway view of an example transfer belt according to an exemplary embodiment;

FIG. 3 is a schematic enlarged view of a partial cross section of the transfer belt indicated by circle III in FIG. 2;

FIG. 4 is a schematic view of an example transfer unit according to an exemplary embodiment;

FIG. 5 is a partial sectional view of example meander control member guides of the transfer unit according to the exemplary embodiment;

FIG. 6 is a partial sectional view of another example meander control member guide of the transfer unit according to the exemplary embodiment; and

FIG. 7 is a schematic view of an example image-forming apparatus according to an exemplary embodiment.

### DETAILED DESCRIPTION

Exemplary embodiments of the present invention will now be described in detail with reference to the drawings. Members having the same functions or effects may be designated by the same reference numerals throughout the drawings to avoid duplication of description.

### Meander Control Member

### First Exemplary Embodiment

A meander control member according to a first exemplary embodiment of the present invention includes a bonding surface to be bonded to an endless belt substrate (hereinafter also referred to as “endless belt”) and a longitudinally extending region other than the bonding surface. The longitudinally extending region contains a polyester elastomer and has a friction coefficient of 0.5 to 0.7 or about 0.5 to about 0.7 (hereinafter also referred to as “low-friction region”).

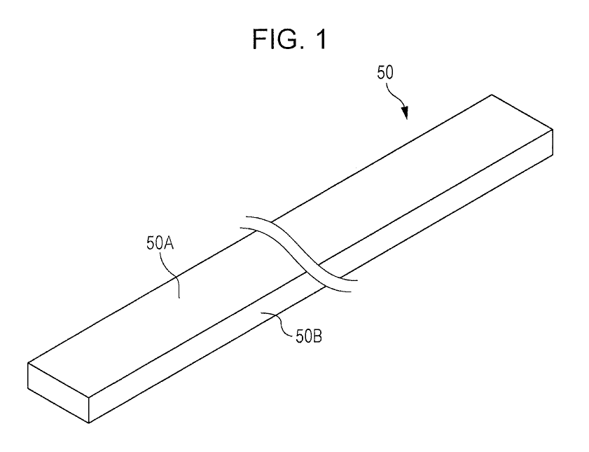

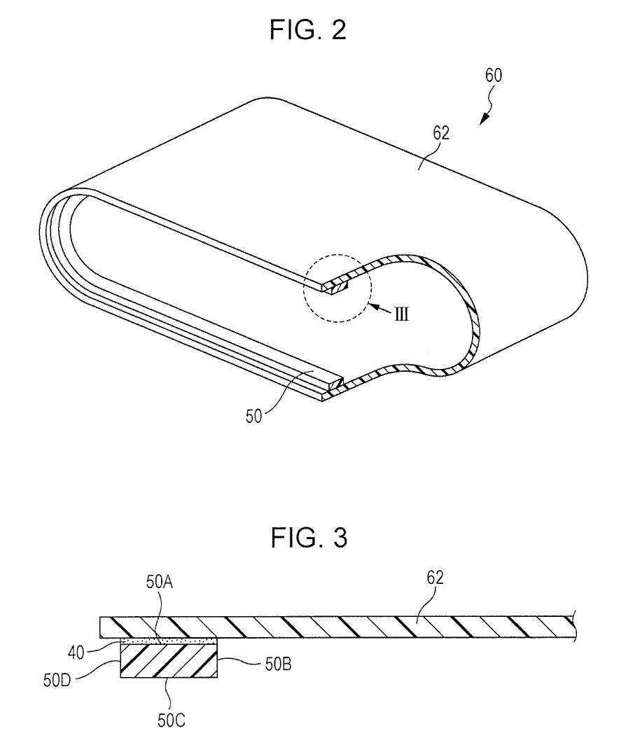

FIG. 1 is a schematic view of an example meander control member according to this exemplary embodiment. FIG. 2 is a schematic partially cutaway view of an example transfer belt including the meander control member shown in FIG. 1. The meander control member is disposed circumferentially at a lateral end of an endless belt substrate (endless belt). FIG. 3 is an enlarged view of a partial cross section indicated by circle III in FIG. 2.

A meander control member 50 shown in FIG. 1 is a strip having a rectangular cross section along the thickness and containing a polyester elastomer. As shown in FIG. 3, the meander control member 50 according to this exemplary embodiment has four longitudinally extending surfaces 50A, 50B, 50C, and 50D. The longitudinally extending surface 50A serves as a bonding surface to be bonded to a belt substrate. The longitudinally extending surfaces 50B, 50C, and 50D other than the bonding surface 50A serve as a low-friction region having a friction coefficient of 0.5 to 0.7 or about 0.5 to about 0.7.

The meander control member 50 according to this exemplary embodiment is mounted, for example, on a transfer belt in an image-forming apparatus. As shown in FIGS. 2 and 3, the bonding surface 50A is bonded circumferentially to a lateral end of a belt substrate 62, for example, using an adhesive. In an image-forming apparatus, the transfer belt 60 is rotatably supported by multiple rollers (support rollers). At least one of the support rollers includes a meander control member guide (limiting member) disposed in contact with any of the surfaces 50B, 50C, and 50D of the meander control member 50 in the longitudinal direction (i.e., in the circumferential direction of the transfer belt 60) to control the lateral movement of the transfer belt 60. The low-friction region of the meander control member 50 according to this exemplary embodiment is disposed in contact with the meander control member guide of the support roller supporting the transfer belt 60. This may reduce wear of the meander control member 50 and may also reduce the risk of breakage of the belt substrate 62. The mechanism is explained as follows.

A meander control member disposed on an endless belt substrate of a transfer belt is generally disposed in contact with a meander control member guide disposed on a roller supporting the transfer belt to control the lateral meandering of the endless belt. The meander control member, however, may wear in the region in contact with the meander control member guide.

Polyester elastomers are generally less expensive than polyurethanes. However, meander control members made of polyester elastomers are susceptible to wear in the region in contact with the meander control member guide. In contrast, the meander control member 50 according to this exemplary embodiment may be slippery against a meander control member guide since the low-friction region, which has a friction coefficient of 0.7 or less or about 0.7 or less, is in contact with the meander control member guide. The meander control member 50 may therefore be resistant to wear even if the meander control member 50 is made of a material containing a polyester elastomer.

If a meander control member experiences insufficient friction in the region in contact with a meander control member guide, the meander control member shifts easily in the axial direction of the meander control member guide and thus moves easily onto the meander control member guide. When the meander control member moves onto the meander control member guide, the meander control member forms a convex surface in the endless belt around the meander control member guide. The endless belt tends to break after repeated bending. If the meander control member moves further over the meander control member guide, the transfer belt becomes separated from the first transfer roller, which tends to result in poor first transfer. In contrast, the meander control member 50 according to this exemplary embodiment, which has a friction coefficient of 0.5 or more or about 0.5 or more in the low-friction region, may be less likely to move onto a meander control member guide due to excessive slip. The meander control member 50 may therefore have a lower risk of breakage of the endless belt.

The polyester elastomer for the meander control member 50 according to this exemplary embodiment is a block copolymer containing hard segments and soft segments. Examples of hard segments include aromatic polyesters. Examples of soft segments include aliphatic polyesters and aliphatic polyethers.

For example, the polyester elastomer for the meander control member 50 according to this exemplary embodiment may be a polyester-ether elastomer, which contains polyester hard segments and polyether soft segments, for reasons of moldability, electrical insulation properties, moisture resistance, solvent resistance, ozone resistance, heat resistance, wear resistance, and ease of manufacture. The polyester elastomer may be manufactured, for example, by transesterification or polycondensation using starting materials such as dimethyl terephthalate, 1,4-butanediol, and poly(oxytetramethylene)glycol.

The meander control member 50 according to this exemplary embodiment may also be made of a commercially available polyester elastomer. Examples of such polyester elastomers include HYTREL® (DuPont), PELPRENE® (Toyobo Co., Ltd.), ESTERAR® (Aronkasei Co., Ltd.), and PRIMALLOY® (Mitsubishi Chemical Corporation).

The meander control member 50 according to this exemplary embodiment may contain materials other than polyester elastomers. Examples of such materials include engineering plastics such as polycarbonates and functional particles such as polytetrafluoroethylene (PTFE) and carbon black.

The meander control member 50 according to this exemplary embodiment includes a longitudinally extending region (low-friction region) other than the bonding surface 50A to be bonded to the belt substrate 62. The longitudinally extending region has a friction coefficient of 0.5 to 0.7 or about 0.5 to about 0.7. Although the meander control member 50 shown in FIG. 1 has a friction coefficient of 0.5 to 0.7 or about 0.5 to about 0.7 in all longitudinally extending surfaces 50B, 50C, and 50D other than the bonding surface 50A, the meander control member 50 only needs to have a friction coefficient of 0.5 to 0.7 or about 0.5 to about 0.7 in the region to be in contact with other components such as meander control member guides. For example, if the meander control member 50 is bonded circumferentially to a lateral end of the belt substrate 62 such that the surface 50B faces inwards and is in contact with a meander control member guide, the meander control member 50 only needs to have a friction coefficient of 0.5 to 0.7 or about 0.5 to about 0.7 in the surface 50B.

The friction coefficient of the meander control member 50 according to this exemplary embodiment is the dynamic friction coefficient measured with felt according to JIS K 7125(1999).

The friction coefficient of the bonding surface 50A of the meander control member 50 according to this exemplary embodiment is preferably, but not limited to, 0.8 to 1.2 or about 0.8 to about 1.2, more preferably 0.8 to 1.0 or about 0.8 to about 1.0. This may reduce the risk of separation of the meander control member 50 from the belt substrate 62 and the risk of breakage of the belt substrate 62.

The friction coefficient of the longitudinally extending surfaces 50A, 50B, 50C, and 50D of the meander control member 50 according to this exemplary embodiment may be adjusted by any process. For example, a strip-shaped meander control member made of a material containing a polyester elastomer may be subjected to treatment such as sandpaper polishing, blasting, priming, or coating, or may be lubricated with lubricating oil.

For example, after a strip-shaped member serving as a meander control member is formed by extrusion molding of a material containing a polyester elastomer, the friction coefficient of the surface to be bonded may be increased by blasting, and the friction coefficient of the surfaces other than the bonding surface may be decreased by polishing with sandpaper.

The width (the distance between the surface 50B and 50D in FIG. 3) and thickness (the distance between the surface 50A and 50C in FIG. 3) of the meander control member 50 may be selected, for example, depending on the conditions where the meander control member 50 is used on the transfer belt 60.

For example, the width of the meander control member 50 is preferably 1 to 10 mm, more preferably 4 to 7 mm, for reasons of meander control effect and durability.

For example, the thickness of the meander control member 50 is preferably, but not limited to, 1 to 5 mm, more preferably 3 to 5 mm, for reasons of meander control effect and durability.

Although the meander control member 50 shown in FIG. 1 has a rectangular cross section along the thickness, i.e., in the direction perpendicular to the longitudinal direction, it may have any other cross section, for example, depending on the shape and position of the support rollers (meander control member guides) to be in contact with the meander control member 50. For example, the meander control member 50 according to this exemplary embodiment may have a polygonal cross section other than rectangular or a curved cross section such as circular or oval along the thickness, i.e., in the direction perpendicular to the longitudinal direction.

The meander control member 50 according to this exemplary embodiment may be formed using a material other than polyester elastomers in the region, including the bonding surface 50A, that is not to be in contact with the support rollers (meander control member guides) and using a polyester elastomer in the region that is to be in contact with the support rollers (meander control member guides).

### Second Exemplary Embodiment

A meander control member according to a second exemplary embodiment of the present invention includes a bonding surface to be bonded to an endless belt substrate and a longitudinally extending region other than the bonding surface. The bonding surface has a friction coefficient of 0.8 to 1.2 or about 0.8 to about 1.2. The longitudinally extending region has a friction coefficient of 0.5 to 0.7 or about 0.5 to about 0.7.

The bonding surface of the meander control member according to the second exemplary embodiment is bonded circumferentially to a lateral end of a belt substrate such that the low-friction region is in contact with a meander control member guide. This may reduce wear of the meander control member and may also reduce the risk of breakage of the belt substrate.

Examples of materials for the meander control member according to the second exemplary embodiment include polyester elastomers and other elastomers with suitable hardness, such as polyurethanes, neoprene rubbers, polyurethane rubbers, silicone rubbers, chloroprene rubbers, and nitrile rubbers. For example, polyurethane rubbers, silicone rubbers, and polyester elastomers may be used for reasons of wear resistance in the region in contact with the meander control member guide, adhesion to the belt substrate, electrical insulation properties, moisture resistance, solvent resistance, ozone resistance, heat resistance, wear resistance, and ease of manufacture.

The process for adjusting the friction coefficient of the longitudinally extending surfaces of the meander control member according to the second exemplary embodiment and the width, thickness, and cross-sectional shape of the meander control member are similar to those of the meander control member according to the first exemplary embodiment, and a description thereof is omitted herein.

### Transfer Belt

A transfer belt according to an exemplary embodiment includes an endless belt substrate and the meander control member according to the first or second exemplary embodiment. The bonding surface is bonded circumferentially to at least one lateral end of the belt substrate.

A transfer belt 60 shown in FIG. 2 includes a belt substrate 62 and a strip-shaped meander control member 50 having a bonding surface 50A bonded circumferentially to at least one lateral end of the inner surface of the belt substrate 62. As shown in FIG. 3, an adhesive layer 40 is disposed between the bonding surface 50A of the meander control member 50 and the belt substrate 62.

### Belt Substrate

The belt substrate 62 is an endless belt containing a resin. The belt substrate 62 may be composed of a single layer or multiple layers.

Examples of resins for the belt substrate 62 include polyimide resins, fluorinated polyimide resins, polyamide resins, polyamide-imide resins, polyether-ether-ester resins, polyarylate resins, and polyester resins. For example, polyimides and polyamide-imides may be used.

### Polyimide Resins

Examples of polyimide resins for belt substrate 62 include imides of polyamic acids prepared by polymerization of tetracarboxylic dianhydrides with diamines. Specific examples of polyimide resins include those prepared by polymerizing a tetracarboxylic dianhydride and a diamine in equimolar amounts in a solvent to obtain a polyamic acid solution and then imidizing the polyamic acid.

Examples of tetracarboxylic dianhydrides include those represented by general formula (I):

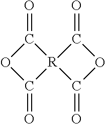

where R is a tetravalent organic group that is an aromatic group, an aliphatic group, an alicyclic group, a combination of aromatic and aliphatic groups, or any substituted derivative thereof.

Specific examples of tetracarboxylic dianhydrides include pyromellitic dianhydride, 3,3′,4,4′-benzophenonetetracarboxylic dianhydride, 3,3′,4,4′-biphenyltetracarboxylic dianhydride, 2,3,3′,4-biphenyltetracarboxylic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl)sulfonic dianhydride, perylene-3,4,9,10-tetracarboxylic dianhydride, bis(3,4-dicarboxyphenyl)ether dianhydride, and ethylenetetracarboxylic dianhydride.

Specific examples of diamines include 4,4′-diaminodiphenyl ether, 4,4′-diaminodiphenylmethane, 3,3′-diaminodiphenylmethane, 3,3′-dichlorobenzidine, 4,4′-diaminodiphenyl sulfide, 3,3′-diaminodiphenylsulfone, 1,5-diaminonaphthalene, m-phenylenediamine, p-phenylenediamine, 3,3′-dimethyl-4,4′-biphenyldiamine, benzidine, 3,3′-dimethylbenzidine, 3,3′-dimethoxybenzidine, 4,4′-diaminodiphenylsulfone, 4,4′-diaminodiphenylpropane, 2,4-bis(β-amino-t-butyl)toluene, bis(p-β-amino-t-butylphenyl)ether, bis(p-β-methyl-δ-aminophenyl)benzene, bis-p-(1,1-dimethyl-5-aminopentyl)benzene, 1-isopropyl-2,4-m-phenylenediamine, m-xylylenediamine, p-xylylenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 1,2-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

The polymerization reaction of the tetracarboxylic dianhydride with the diamine may be performed, for example, in a polar solvent (organic polar solvent) for reasons of solubility. Examples of polar solvents include N,N-dialkylamides, including low-molecular-weight N,N-dialkylamides such as N,N-dimethylformamide, N,N-dimethylacetamide, N,N-diethylformamide, N,N-diethylacetamide, N,N-dimethylmethoxyacetamide, dimethyl sulfoxide, hexamethylphosphortriamide, N-methyl-2-pyrrolidone, pyridine, tetramethylenesulfone, and dimethyltetramethylenesulfone. These may be used alone or in combination.

### Polyamide-Imide Resins

Polyamide-imide resins are resins having imide and amide groups in a molecule. Polyamide-imide resins of commonly known structures may be used for the belt substrate 62. Known processes for synthesizing polyamide-imide resins include the acid chloride route and the isocyanate route, either of which may be used. The isocyanate route may be used for reasons of the stability of the resulting polyamide-imide resin solution.

The isocyanate route involves reacting a carboxylic acid anhydride with a diisocyanate. The acid chloride route involves reacting a carboxylic acid chloride with a diamine. The carboxylic acid anhydride and the carboxylic acid chloride are hereinafter also referred to as “carboxylic acid component”.

Examples of carboxylic acid anhydrides include trimellitic anhydride and derivatives thereof, which may be used in combination with carboxylic acid anhydrides capable of reacting with isocyanate or amino groups (e.g., dicarboxylic acid anhydrides and tetracarboxylic acid anhydrides).

The diisocyanate is a compound represented by general formula (II):

O═C═N—R—N═C═O (II)

where R is a divalent aromatic or aliphatic group.

Specific examples of diisocyanates include the following compounds, which may be used alone or in combination:

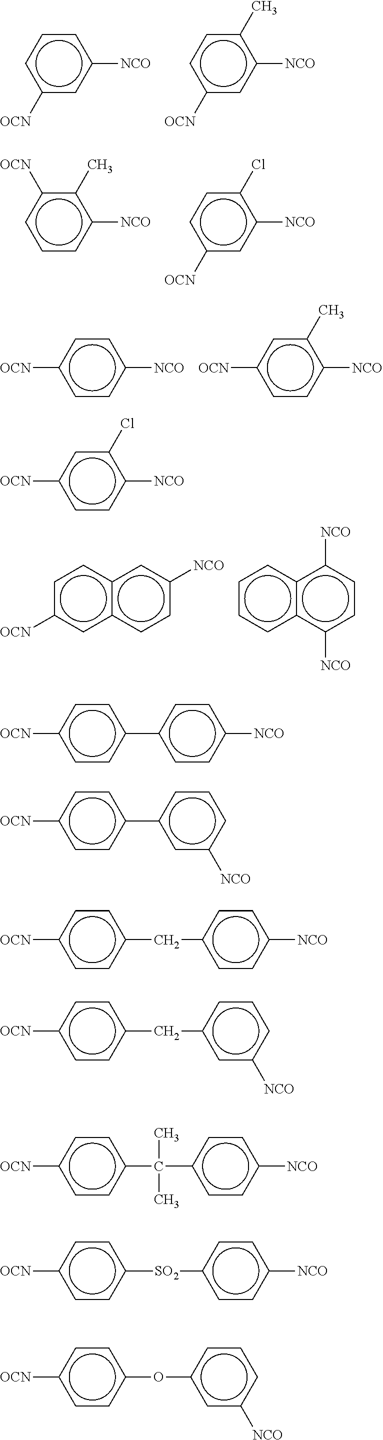

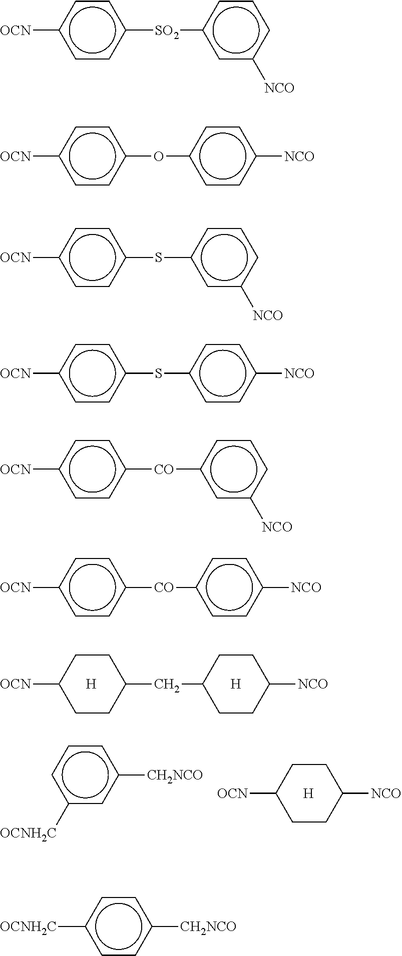

Examples of carboxylic acid chlorides include trimellitic chloride and derivatives thereof, which may be used in combination with one or more other carboxylic acid chlorides such as dicarboxylic acid chlorides and tetracarboxylic acid chlorides.

Examples of diamines include aliphatic diamines such as ethylenediamine, propylenediamine, and hexamethylenediamine; alicyclic diamines such as 1,4-cyclohexanediamine, 1,3-cyclohexanediamine, isophoronediamine, and 4,4′-diaminodicyclohexylmethane; and aromatic diamines such as m-phenylenediamine, p-phenylenediamine, 4,4′-diaminodiphenylmethane, 4,4′-diaminodiphenyl ether, 4,4′-diaminodiphenylsulfone, benzidine, o-tolidine, 2,4-tolylenediamine, 2,6-tolylenediamine, and xylylenediamine. For example, diamines such as 4,4′-diaminodiphenylmethane, isophoronediamine, and 4,4′-diaminodicyclohexylmethane are performed for reasons of heat resistance, mechanical properties, and solubility.

The isocyanate or the diamine and the carboxylic acid component are preferably blended such that the ratio of the total number of moles of isocyanate or amino groups to the total number of moles of carboxyl groups and acid anhydride groups in the acid component is 0.6 to 1.4, more preferably 0.7 to 1.3, even more preferably 0.8 to 1.2.

Specific examples of methods for manufacturing polyamide-imide resins by the isocyanate route include the following methods:

(1) simultaneously reacting an isocyanate component with a tricarboxylic acid component to obtain a polyamide-imide resin;

(2) reacting an excess of an isocyanate component with a tricarboxylic acid component to obtain an amide-imide oligomer having isocyanate end groups and then adding and reacting the acid component to obtain a polyamide-imide resin; and

(3) reacting an excess of a tricarboxylic acid component with an isocyanate component to obtain an amide-imide oligomer having carboxylic acid or acid anhydride end groups and then adding and reacting the acid component and the isocyanate component to obtain a polyamide-imide resin.

The polyamide-imide resin may be manufactured either by simultaneously performing an amidation reaction and an imidation reaction or by performing an imidation reaction upon completion of an amidation reaction.

The belt substrate 62 used in this exemplary embodiment may contain two or more resins and may be made of a commercially available resin. Examples of such resins include the products used for the fabrication of belt substrates in the examples described later.

The belt substrate 62 used in this exemplary embodiment may contain materials other than resins. Examples of such materials include conductors such as carbon black, antioxidants, surfactants, and particles such as PTFE and SiO₂ particles.

The belt substrate 62 may have a thickness of, for example, 0.02 to 0.2 mm if the transfer belt 60 according to this exemplary embodiment is used as an intermediate transfer belt.

The belt substrate 62 used in this exemplary embodiment may be manufactured by any known method. A method for manufacturing a belt substrate 62 containing a polyimide resin as a resin material and carbon black as a conductor will now be described, although other methods may also be used.

A core is provided first. Examples of cores include cylindrical molds. Examples of core materials include metals such as aluminum, stainless steel, and nickel. The length of the core is larger than or equal to that of the target belt substrate. For example, the length of the core may be 10% to 40% larger than that of the target belt substrate.

A polyamic acid solution having carbon black dispersed therein is then prepared as a coating composition for the manufacture of belt substrates.

Specifically, the polyamic acid solution having carbon black dispersed therein may be prepared, for example, by dissolving a tetracarboxylic dianhydride and a diamine in an organic polar solvent, dispersing carbon black in the solution, and polymerizing the tetracarboxylic dianhydride and the diamine.

The monomer concentration of the polyamic acid solution (i.e., the concentration of the tetracarboxylic dianhydride and the diamine in the solvent) varies depending on various conditions. For example, the monomer concentration may be 5% to 30% by mass. The polymerization reaction temperature is preferably 80° C. or lower, more preferably 5° C. to 50° C. The polymerization reaction time may be 5 to 10 hours.

The coating composition for the manufacture of belt substrates is then applied to the cylindrical mold serving as the core to form a coating.

The coating composition may be applied to the cylindrical mold by any method, such as by dipping the outer surface of the cylindrical mold in the coating composition, by dipping the inner surface of the cylindrical mold in the coating composition, or by applying the coating composition to the outer or inner surface of the cylindrical mold while rotating the cylindrical mold with the axis thereof oriented horizontally, i.e., by spiral coating or die coating.

The coating of the coating composition for the manufacture of belt substrates is then dried to form a film (dry coating before imidation). The coating may be dried, for example, at 80° C. to 200° C. for 10 to 60 minutes. The heating time may be shorter at higher temperatures. It is also effective to apply hot air during heating. The heating temperature may be increased stepwise or may be increased at constant rate. The core may be rotated at 5 to 60 rpm with the axis thereof oriented horizontally. After drying, the core may be oriented vertically.

The film is then imidized (baked).

The film may be imidized (baked), for example, at 250° C. to 450° C. (preferably, 300° C. to 350° C.) for 20 to 60 minutes. This induces an imidization reaction to form a polyimide resin film. During the heating reaction, the heating temperature may be gradually increased stepwise or continuously before the final heating temperature is reached.

After imidization, the film (polyimide resin film) is removed from the core. A belt substrate is thus obtained.

### Meander Control Member

The meander control member 50 is the meander control member according to the first or second exemplary embodiment, and a description thereof is omitted herein.

The meander control member 50 is bonded circumferentially to an end of the inner surface of the belt substrate 62. The meander control member 50 may be bonded to the end of the belt substrate 62 at any position (i.e., at any distance from the edge of the belt substrate 62) depending on, for example, the application and function of the transfer belt 60 and the type of apparatus to which the transfer belt 60 is applied. For example, the meander control member 50 may be bonded such that the outer lateral end surface 50D thereof is flush with the lateral end surface of the belt substrate 62.

The meander control member 50 may be continuously provided over the entire circumference of the belt substrate 62 or may be divided into multiple meander control members 50 in the circumferential direction of the belt substrate 62.

The meander control member 50 may be disposed at one lateral end of the belt substrate 62 or may be disposed at each lateral end of the belt substrate 62.

Although the transfer belt 60 shown in FIG. 2 includes the meander control member 50 disposed on the inner surface of the belt substrate 62, the meander control member 50 may instead be disposed on the outer surface of the belt substrate 62, depending on, for example, the position of the meander control member guide.

### Adhesive Layer

The adhesive layer 40 may be made of, for example, a known adhesive or adhesive sheet. For example, elastic adhesives and thermosensitive adhesive sheets may be used.

### Elastic Adhesives

Examples of elastic adhesives include Super-X No. 8008 from Cemedine Co., Ltd., which is based on an acrylic-modified silicone polymer, and Silex 100 from Konishi Co., Ltd., which is based on a special modified silicone polymer. Super-X No. 8008 from Cemedine Co., Ltd., which is based on an acrylic-modified silicone polymer, may be used for reasons of the adhesion strength to the belt substrate 62.

### Thermosensitive Adhesive Sheets

The adhesive layer 40 may be made of any thermosensitive adhesive sheet that provides high adhesion between the belt substrate 62 and the meander control member 50. Examples of such thermosensitive adhesive sheets include adhesive sheets based on resin materials such as acrylic resins, silicone resins, natural and synthetic rubbers, urethane resins, vinyl chloride-vinyl acetate copolymer resins, and other synthetic resins.

Specific examples include GM-913 and GM-920 polyester adhesive sheets from Toyobo Co., Ltd. and D3600 polyester adhesive sheets from Sony Chemicals Corporation. D3600 polyester adhesive sheets from Sony Chemicals Corporation and GM-920 polyester adhesive sheets from Toyobo Co., Ltd. may be used for reasons of the adhesion strength to the belt substrate 62.

The adhesive layer 40 preferably has a thickness of 0.01 to 0.3 mm, more preferably 0.02 to 0.05 mm. If the adhesive layer 40 has a thickness of 0.01 mm or more, it may have uniform adhesion strength. If the adhesive layer 40 has a thickness of 0.3 mm or less, it may prevent displacement of the meander control member 50 due to uneven bonding.

### Transfer Unit

A transfer unit according to an exemplary embodiment includes the transfer belt according to the previous exemplary embodiment and multiple rollers rotatably supporting the transfer belt. The rollers include at least one roller disposed in contact with the region (low-friction region) of the meander control member having a friction coefficient of 0.5 to 0.7 or about 0.5 to about 0.7 to control the lateral movement of the transfer belt.

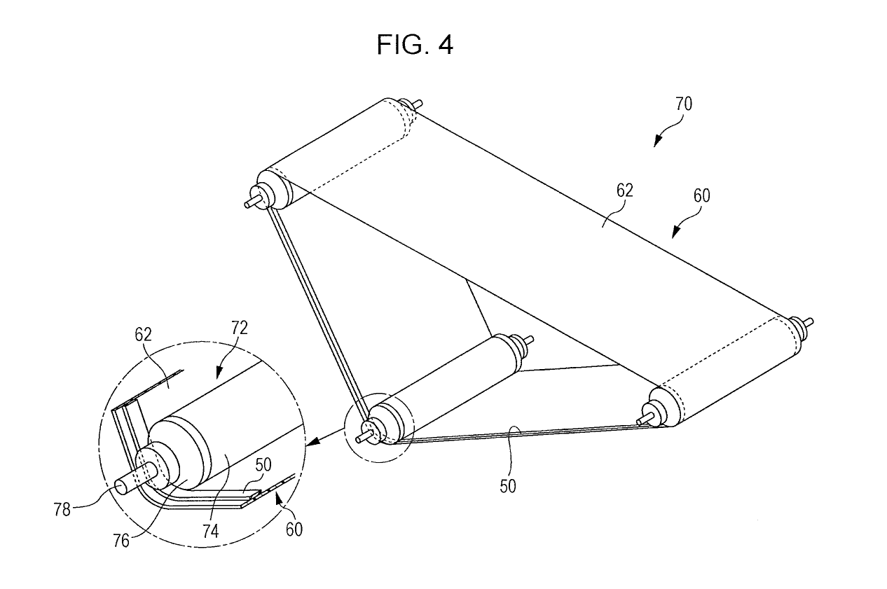

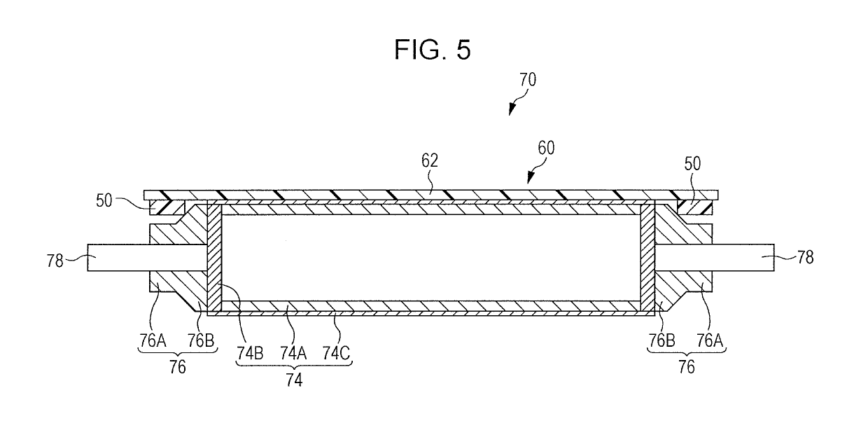

FIG. 4 is a schematic sectional view of an example transfer unit according to this exemplary embodiment. FIG. 5 is a partial sectional view of the example transfer unit according to this exemplary embodiment. A transfer unit 70 shown in FIG. 5 includes meander control members 50 at both ends of the inner surface of the belt substrate 62.

The transfer unit 70 includes the transfer belt 60 according to the previous exemplary embodiment and guide-equipped support rollers 72 disposed in contact with the inner surface of the transfer belt 60 and rotatably supporting the transfer belt 60. Each guide-equipped support roller 72 includes meander control member guides 76 (limiting members) disposed in contact with the meander control member guides 50 of the transfer belt 60 to control the lateral movement of the transfer belt 60. Although the transfer unit 70 shown in FIG. 4 includes three guide-equipped support rollers 72, it may include any number of support rollers provided that it includes at least one guide-equipped support roller 72.

Each guide-equipped support roller 72 includes a support roller body 74 disposed in contact with the inner surface of the transfer belt 60, meander control member guides 76 (limiting members) disposed at both axial ends of the support roller body 74, and shafts 78 coupled to the centers of both axial end surfaces of the support roller body 74 and extending axially outward through the meander control member guides 76.

The support roller body 74 is disposed in contact with the inner surface of the transfer belt 60 to hold the transfer belt 60 under tension together with the other support rollers 72. The support roller body 74 includes a cylinder 74A having openings at both axial ends thereof and lids 74B covering the openings. The support roller body 74 is made of, for example, aluminum.

A high-friction material layer 74C is disposed on the outer surface of the support roller body 74 to prevent the belt substrate 62 from slipping under load. The high-friction material layer 74C is, for example, a polyurethane layer (having a thickness of 5 to 50 μm, preferably about 25 μm).

The meander control member guides 76 are disposed in contact with the meander control member 50 to limit the lateral movement of the transfer belt 60. Each meander control member guide 76 includes, for example, a small-diameter portion 76A and a large-diameter portion 76B located closer to the support roller body 74 than the small-diameter portion 76A. The small-diameter portion 76A and the large-diameter portion 76B are coaxially and integrally formed with a truncated conical portion therebetween. The shafts 78 extend through the meander control member guides 76, which are coaxial with the support roller body 74. The meander control member guides 76 may be made of a resin material with high surface smoothness and good slidability, for example, polyacetal.

In this exemplary embodiment, as shown in FIG. 5, the inner side surfaces 50B of the meander control members 50 and the corners between the inner side surfaces 50B and the surfaces 50C opposite the bonding surfaces 50A are disposed in contact with the truncated conical portions between the large-diameter portions 76B and the large-diameter portions 76B of the meander control member guides 76 to limit the axial movement of the transfer belt 60. The meander control members 50 used in this exemplary embodiment have a friction coefficient of 0.5 to 0.7 or about 0.5 to about 0.7 in all surfaces 50B, 50C, and 50D other than the bonding surface 50A. This may reduce wear of the meander control members 50 and may also reduce the risk of breakage of the belt substrate 62 when the meander control members 50 are disposed in contact with the meander control member guides 76, as shown in FIG. 5.

In the exemplary embodiment shown in FIG. 5, the meander control member guides 76 are disposed at both axial ends of the support roller body 74. If a meander control member 50 is disposed at only one axial end of the belt substrate 62, a meander control member guide 76 may be disposed at the axial end of the support roller body 74 where the meander control member 50 of the transfer belt 60 is disposed.

The guide-equipped support rollers 72 disposed in the transfer unit 70 may be various types of rollers such as tension rollers, steering rollers, idle rollers, drive rollers, and backup rollers, depending on the application. In the transfer unit according to this exemplary embodiment, which includes multiple support rollers, for example, as shown in FIG. 4, not all rollers need to be guide-equipped support rollers; the transfer unit according to this exemplary embodiment has a meander control member guide 76 on at least one support roller.

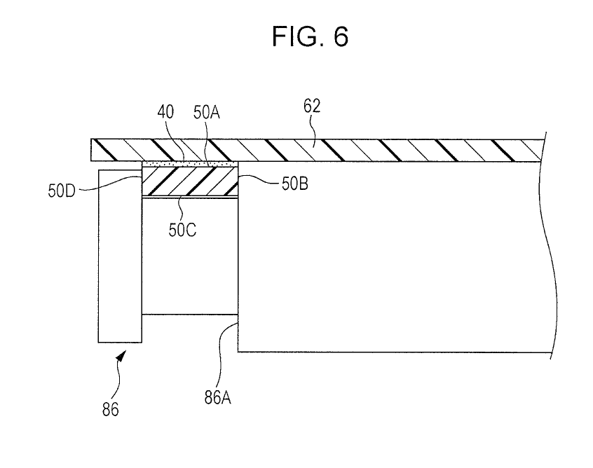

The meander control member guides 76 may have other structures. For example, the meander control member guides 76 may be solid or hollow cylindrical members having grooves or notches extending circumferentially for insertion of the meander control members 50. For example, as shown in FIG. 6, meander control member guides 86 having grooves 89A for insertion of the meander control members 50 may be used. When the meander control members 50 are disposed in the grooves 86A on the meander control member guides 86, the inner side surfaces 50B and the outer side surfaces 50D of the meander control members 50 are in contact with the inner walls of the grooves 86A on the meander control member guides 86. The meander control members 50 have a friction coefficient of 0.5 to 0.7 or about 0.5 to about 0.7 in the side surfaces 50B and 50D, which serve as a low-friction region. This may reduce wear of the meander control members 50 and may also reduce the risk of breakage of the belt substrate 62 when the meander control members 50 are disposed in contact with the inner walls of the grooves 86A on the meander control member guides 86, as shown in FIG. 6.

### Image-Forming Apparatus

An image-forming apparatus according to an exemplary embodiment will now be described. The image-forming apparatus according to this exemplary embodiment includes an electrophotographic photoreceptor having a surface, a charging unit that charges the surface of the electrophotographic photoreceptor, an electrostatic-latent-image forming unit that forms an electrostatic latent image on the charged surface of the electrophotographic photoreceptor, a developing unit that develops the electrostatic latent image formed on the surface of the electrophotographic photoreceptor with a developer containing a toner to form a toner image, and a transfer unit including the transfer belt according to the previous exemplary embodiment and multiple rollers rotatably supporting the transfer belt. The rollers include at least one roller disposed in contact with the region of the meander control member having a friction coefficient of 0.5 to 0.7 or about 0.5 to about 0.7 to control the lateral movement of the transfer belt. The transfer unit transfers the toner image from the surface of the electrophotographic photoreceptor to a surface of a recording medium via the transfer belt.

For example, the image-forming apparatus according to this exemplary embodiment may be a monochrome image-forming apparatus including a single developing device containing a toner. Alternatively, the image-forming apparatus according to this exemplary embodiment may be a color image-forming apparatus that includes multiple developing devices containing toners of different colors and that forms a color image by sequentially transferring toner images of different colors from the surfaces of electrophotographic photoreceptors to a belt substrate serving as an intermediate transfer member such that they are superimposed on top of each other.

As an example image-forming apparatus according to this exemplary embodiment, an image-forming apparatus that forms a color image by superimposing toner images of different colors on top of each other will now be described.

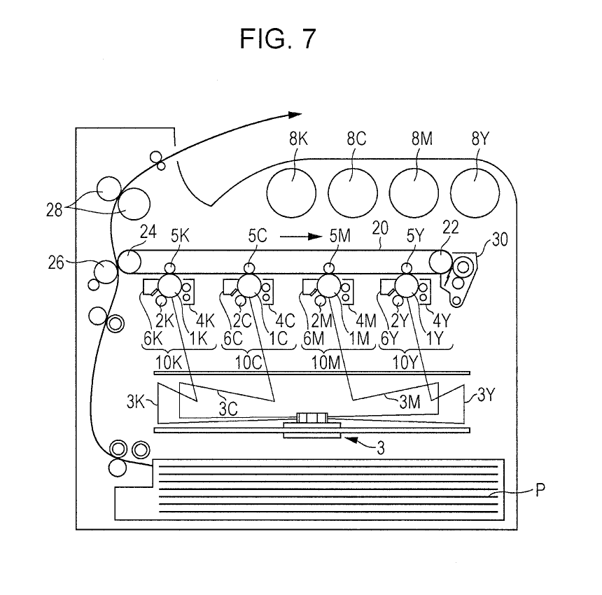

FIG. 7 is a schematic view of an example image-forming apparatus according to this exemplary embodiment. The image-forming apparatus shown in FIG. 7 includes first to fourth electrophotographic image-forming units (hereinafter referred to as “units”) 10Y, 10M, 10C, and 10K that form yellow (Y), magenta (M), cyan (C), and black (K) images, respectively, based on color separation image data. These units 10Y, 10M, 10C, and 10K are arranged side by side at a particular distance from each other in the horizontal direction. These units 10Y, 10M, 10C, and 10K may be process cartridges attachable to and detachable from the image-forming apparatus.

An intermediate transfer belt 20 serving as an intermediate transfer member is disposed above the units 10Y, 10M, 10C, and 10K in FIG. 7 and passes through each unit. The intermediate transfer belt 20 is the transfer belt according to the previous exemplary embodiment. The intermediate transfer belt 20 is entrained about a drive roller 22 and a support roller 24. The two rollers 22 and 24 are disposed in contact with the inner surface of the intermediate transfer belt 20 and are separated from each other in the direction from left to right in FIG. 7. The intermediate transfer belt 20 moves (rotates) in the direction from the first unit 10Y toward the fourth unit 10K. The intermediate transfer belt 20 and the two rollers 22 and 24 constitute a transfer unit in the image-forming apparatus.

The drive roller 22 and the support roller 24 are equipped with the meander control member guides 76.

The support roller 24 is biased away from the drive roller 22 by elements such as springs (not shown) to apply a particular tension to the intermediate transfer belt 20 entrained about the two rollers 22 and 24. An intermediate-transfer-member cleaning device 30 is disposed on the image carrier side of the intermediate transfer belt 20 at the position opposite the drive roller 22.

The units 10Y, 10M, 10C, and 10K include developing devices (developing units) 4Y, 4M, 4C, and 4K, respectively. The developing devices 4Y, 4M, 4C, and 4K are supplied with yellow, magenta, cyan, and black toners from toner cartridges 8Y, 8M, 8C, and 8K, respectively.

Since the first to fourth units 10Y, 10M, 10C, and 10K have the same configuration, the following description will focus on the first unit 10Y, which is a yellow image-forming unit located upstream in the moving direction of the intermediate transfer belt 20. Elements corresponding to those of the first unit 10Y are designated by like numerals with the suffix M (magenta), C (cyan), or K (black), rather than the suffix Y (yellow), and a description of the second to fourth units 10M, 10C, 10K is omitted herein.

The first unit 10Y includes a photoreceptor 1Y serving as an image carrier. The photoreceptor 1Y is surrounded, in sequence, by a charging roller 2Y that charges the surface of the photoreceptor 1Y to a particular potential, an exposure device 3 that exposes the charged surface to a laser beam 3Y based on a color separation image signal to form an electrostatic image, a developing device (developing unit) 4Y that supplies a charged toner to the electrostatic image to develop the electrostatic image with the toner, a first transfer roller (first transfer unit) 5Y that transfers the resulting toner image to the intermediate transfer belt 20, and a photoreceptor-cleaning device (cleaning unit) 6Y that removes residual toner from the surface of the photoreceptor 1Y with a cleaning blade after the first transfer.

The first transfer roller 5Y is disposed inside the intermediate transfer belt 20 at the position opposite the photoreceptor 1Y. Bias power supplies (not shown) are connected to the first transfer rollers 5Y, 5M, 5C, and 5K to apply a first transfer bias thereto. A controller (not shown) controls the bias power supplies to change the transfer bias applied to the first transfer rollers 5Y, 5M, 5C, and 5K. The first transfer rollers 5Y, 5M, 5C, and 5K include the meander control member guides 76.

The operation of forming a yellow image in the first unit 10Y will now be described. Before the operation, the charging roller 2Y charges the surface of the photoreceptor 1Y to a potential of about −600 to about −800 V.

The photoreceptor 1Y includes a conductive substrate (e.g., a substrate having a volume resistivity at 20° C. of 1×10⁶ Ωcm or less) and a photosensitive layer disposed thereon. The photosensitive layer, which normally exhibits high resistivity (i.e., a resistivity similar to those of common resins), has the property of changing its resistivity in a region irradiated with the laser beam 3Y. The laser beam 3Y is emitted from the exposure device 3 toward the charged surface of the photoreceptor 1Y based on yellow image data received from a controller (not shown). The laser beam 3Y impinges on the photosensitive layer of the photoreceptor 1Y to form an electrostatic image corresponding to a yellow print pattern on the surface of the photoreceptor 1Y.

Electrostatic images are images formed on the surface of the photoreceptor 1Y by electric charge. Electrostatic images are negative latent images formed when electric charge dissipates from the surface of the photoreceptor 1Y due to decreased resistivity of the photosensitive layer in a region irradiated with the laser beam 3Y while remaining in a region not irradiated with the laser beam 3Y.

As the photoreceptor 1Y rotates, the electrostatic image formed on the photoreceptor 1Y is transported to a particular development position. The electrostatic image is made visible (i.e., developed) at the development position by the developing device 4Y.

The developing device 4Y contains, for example, a yellow toner. The yellow toner is triboelectrically charged while being stirred inside the developing device 4Y. The yellow toner is charged to the same polarity (i.e., negative) as the surface of the photoreceptor 1Y and is carried by a developer roller (developer carrier). As the surface of the photoreceptor 1Y passes through the developing device 4Y, the yellow toner is electrostatically attracted to the latent image on the surface of the photoreceptor 1Y to develop the latent image with the yellow toner. The photoreceptor 1Y having the yellow toner image formed thereon continues to rotate at a particular speed and transports the toner image to a particular first transfer position.

When the yellow toner image on the photoreceptor 1Y is transported to the first transfer position, a particular first transfer bias is applied to the first transfer roller 5Y. The first transfer bias exerts an electrostatic force from the photoreceptor 1Y to the first transfer roller 5Y to transfer the toner image from the photoreceptor 1Y to the intermediate transfer belt 20. The first transfer bias has the opposite polarity (i.e., positive) to the toner (i.e., negative). For example, the transfer bias applied in the first unit 10Y is controlled to about +10 μA by a controller (not shown).

The cleaning device 6Y removes and collects residual toner from the photoreceptor 1Y.

The first transfer biases applied to the first transfer rollers 5M, 5C, and 5K of the second to fourth units 10M, 10C, and 10K are controlled in the same manner.

In this way, the intermediate transfer belt 20 having the yellow toner image transferred thereto by the first unit 10Y is sequentially transported through the second to fourth units 10M, 10C, and 10K, where toner images of different colors are transferred to the intermediate transfer belt 20 such that they are superimposed on top of each other.

After the toner images of the four colors are transferred to the intermediate transfer belt 20 by the first to fourth units 10Y, 10M, 10C, and 10K, the superimposed toner image is transported to a second transfer section. The second transfer section includes the intermediate transfer belt 20, the support roller 24 disposed in contact with the inner surface of the intermediate transfer belt 20, and a second transfer roller (second transfer unit) 26 disposed on the image carrier side of the intermediate transfer belt 20. A recording medium P is fed into a nip between the second transfer roller 26 and the intermediate transfer belt 20 at a particular timing by a feed mechanism. A second transfer bias is then applied to the support roller 24. The second transfer bias, which has the same polarity (i.e., negative) as the toner (i.e., negative), exerts an electrostatic force from the intermediate transfer belt 20 toward the recording medium P to transfer the toner image from the intermediate transfer belt 20 to the recording medium P. The second transfer bias is determined and controlled depending on the resistance detected by a resistance detector (not shown) that detects the resistance of the second transfer section.

The recording medium P is then transported to and heated by a fixing device (fixing unit) 28. The superimposed toner image is melted and fixed to the recording medium P. After the fixing of the color image is complete, the recording medium P is transported to an output section. The color-image forming operation is thus complete.

Although the illustrated image-forming apparatus is configured to transfer multiple toner images to the recording medium P via the intermediate transfer belt 20 such that they are superimposed on top of each other, the image-forming apparatus according to this exemplary embodiment may have other configurations. For example, the image-forming apparatus according to this exemplary embodiment may be configured to transfer a monochrome toner image from the surface of a photoreceptor to a recording medium via the intermediate transfer belt 20.

### EXAMPLES

The present invention is further illustrated by the following examples, although these examples are not intended to limit the scope of the present invention.

### Fabrication of Endless Belt

Carbon black (FW1, Degussa) is added to a polyamide-imide resin solution (HPC-9000, Hitachi Chemical Co., Ltd., solid content: 18% by mass, solvent: n-methyl-2-pyrrolidone) in an amount of 4% by mass on a solid basis and is dispersed in a jet mill (Geanus PY, Geanus) (200 N/mm², 5 passes).

The resulting dispersion of carbon black in the polyamide-imide resin solution is passed through a 20 μm stainless steel mesh to remove foreign matter and aggregated carbon black. The dispersion is then degassed in a vacuum with stirring for 15 minutes to obtain a coating composition for forming endless belts (solid content: 21% by mass).

The resulting coating composition is applied to the outer surface of an aluminum pipe and is dried at 150° C. for 30 minutes while the aluminum pipe is being rotated.

The aluminum pipe is placed in an oven at 315° C. for 1 hour and is then removed from the oven. The resulting resin film on the outer surface of the aluminum pipe is removed from the aluminum pipe to obtain an endless belt substrate (endless belt) having a thickness of 0.08 mm.

### Example 1

### Fabrication of Meander Control Member

A meander control member is fabricated from a polyester-ether elastomer sheet having a thickness of 1 mm.

The meander control member has a width of 5 mm and a length sufficient to be bonded to an end of the inner surface of the endless belt substantially over the entire circumference. The friction coefficient of the surface to be bonded to the endless belt (i.e., the bonding surface) is adjusted by blasting, whereas the friction coefficient of the three surfaces other than the bonding surface is adjusted by sandpaper polishing. The resulting meander control member is referred to as Meander Control Member 1. Blasting and sandpaper polishing are performed as follows.

### Blasting

The surface of the material is blasted with alumina particles by the wet blasting process disclosed in Japanese Unexamined Patent Application Publication No. 2004-246124 to obtain a sample having the target friction coefficient.

### Sandpaper Polishing

The surface of the material is polished with 400- to 2000-grit sandpaper to obtain a sample having the target friction coefficient.

The friction coefficients of the bonding surface and the surface, to be in contact with meander control member guides, of the resulting meander control member are measured by the method described above.

### Fabrication of Meander-Control-Member-Equipped Transfer Belt

An elastic adhesive, i.e., Super-X No. 8008 from Cemedine Co., Ltd., which is based on an acrylic-modified silicone polymer, is applied to a thickness of 20 μm on the bonding surface, to be bonded to the endless belt, of Meander Control Member 1.

Meander Control Member 1 is placed circumferentially at one lateral end of the inner surface of the endless belt such that the bonding surface coated with the elastic adhesive faces the inner surface of the endless belt. Meander Control Member 1 is bonded to the endless belt by pressing at a pressure of 0.03 MPa to obtain a meander-control-member-equipped transfer belt.

### Examples 2 to 4 and Comparative Examples 1 to 3

### Fabrication of Meander Control Member

Meander Control Members 2 to 7 are fabricated as in Example 1 except that the friction coefficients of the longitudinally extending surfaces are adjusted as shown in Table 1.

Sandpaper polishing is performed to achieve a friction coefficient of 0.5 to 0.7, whereas blasting is performed to achieve a friction coefficient of more than 0.7. The friction coefficient is adjusted depending on the particle size of the blasting media (alumina particles), the grit of the sandpaper, and the processing time.

### Fabrication of Meander-Control-Member-Equipped Transfer Belt

Meander-control-member-equipped transfer belts are fabricated as in Example 1 except that the meander control members shown in Table 1 are used.

### Evaluation

### Print Test

The meander-control-member-equipped transfer belt fabricated in each example is mounted as an intermediate transfer belt on a modified ApeosPort-IV C5575 laser printer available from Fuji Xerox Co., Ltd. A total of 1,000,000 copies are printed on A4 landscape sheets.

### Image Quality Evaluation

The 1,000,000th copy is examined for image quality (color misregistration and missing color) under a microscope and is evaluated according to the following criteria:

A: The maximum amount of color misregistration is 50 μm or less, and there is no missing color.

B: The maximum amount of color misregistration is more than 50 μm, or there is a missing color.

### Evaluation of Transfer Belt

After 1,000,000 copies are printed, the intermediate transfer belt is detached from the printer and is evaluated for the separation of the meander control member from the endless belt, the wear of the meander control member in the region in contact with the meander control member guide, and the breakage of the endless belt according to the following criteria.

The amount of wear of the meander control member is determined as the average difference between the widths of the meander control member measured before and after the print test at three points in the longitudinal direction. The separation of the meander control member from the endless belt and the breakage of the endless belt are determined by visual inspection.

### Separation

A: The meander control member is not separated from the endless belt.

B: The meander control member is separated from the endless belt in part of the bonding surface.

### Wear

A: The amount of wear in the region in contact with the meander control member guide is less than 5 μm.

B: The amount of wear in the region in contact with the meander control member guide is from 5 μm to less than 50 μm.

C: The amount of wear in the region in contact with the meander control member guide is 50 μm or more.

### Belt Breakage

A: The endless belt is not broken.

B: The endless belt is partially broken (cracked).

The materials, friction coefficients, and evaluation results of the meander control members fabricated in the examples and the comparative examples are summarized in Table 1.

TABLE 1

| | Meander control member | | | | | | |
|---|---|---|---|---|---|---|---|
| | | Friction | | | | | |
| | | coefficient | | | | | |
| | | Belt | Guide | Evaluation | | | |
| | | bonding | contact | | | | Belt |
| | No. | surface | surface | Image quality | Separation | Wear | breakage |
| Example 1 | 1 | 0.8 | 0.5 | A | A | A | A |
| Example 2 | 2 | 1.2 | 0.5 | A | A | A | A |
| Example 3 | 3 | 0.8 | 0.7 | A | A | A | A |
| Example 4 | 4 | 1.2 | 0.7 | A | A | A | A |
| Comparative | 5 | 0.4 | 0.4 | B (color | B | A | B |
| Example 1 | | | | misregistration) | | | |
| Comparative | 6 | 0.8 | 0.8 | B (missing) | A | B | A |
| Example 2 | | | | color) | | | |
| Comparative | 7 | 1.3 | 1.3 | B (missing color) | A | C | B |
| Example 3 | | | | | | | |

The meander control members made of a polyester elastomer and having a guide contact surface with a friction coefficient of 0.5 to 0.7 may have a higher resistance to wear in the guide contact surface and may have a lower risk of belt breakage. The meander control member having a belt bonding surface with a friction coefficient of less than 0.7 causes color misregistration because of its separation.

The meander control members having a guide contact surface with a friction coefficient of more than 0.7 cause missing colors because of the deposition of a large amount of wear particles on the transfer belt. The meander control member having a guide contact surface with a friction coefficient of more than 1.2 causes belt breakage after repeated bending since the endless belt is noticeably depressed when bent by the support rollers.

The meander control member having a guide contact surface with a friction coefficient of less than 0.5 causes belt breakage after repeated bending since the meander control member moves onto the meander control member guide and forms a convex surface in the endless belt.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A meander control member comprising:
a bonding surface to be bonded to an endless belt substrate; and
a longitudinally extending region other than the bonding surface, the longitudinally extending region comprising a polyester elastomer and having a friction coefficient of about 0.5 to about 0.7.

2. The meander control member according to claim 1, wherein the bonding surface has a friction coefficient of about 0.8 to about 1.2.

3. A meander control member comprising:
a bonding surface to be bonded to an endless belt substrate, the bonding surface having a friction coefficient of about 0.8 to about 1.2; and
a longitudinally extending region other than the bonding surface, the longitudinally extending region having a friction coefficient of about 0.5 to about 0.7.

4. The meander control member according to claim 1, wherein all longitudinally extending surfaces other than the bonding surface have a friction coefficient of about 0.5 to about 0.7.

5. The meander control member according to claim 2, wherein all longitudinally extending surfaces other than the bonding surface have a friction coefficient of about 0.5 to about 0.7.

6. The meander control member according to claim 3, wherein all longitudinally extending surfaces other than the bonding surface have a friction coefficient of about 0.5 to about 0.7.

7. A transfer belt comprising:
an endless belt substrate; and
the meander control member according to claim 1, the bonding surface being bonded circumferentially to at least one lateral end of the belt substrate.

8. A transfer unit comprising:
the transfer belt according to claim 7; and
a plurality of rollers rotatably supporting the transfer belt, the rollers including at least one roller disposed in contact with the region of the meander control member having a friction coefficient of about 0.5 to about 0.7 to control the lateral movement of the transfer belt.

9. An image-forming apparatus comprising:
an electrophotographic photoreceptor having a surface;
a charging unit that charges the surface of the electrophotographic photoreceptor;
an electrostatic-latent-image forming unit that forms an electrostatic latent image on the charged surface of the electrophotographic photoreceptor;
a developing unit that develops the electrostatic latent image formed on the surface of the electrophotographic photoreceptor with a developer containing a toner to form a toner image; and
a transfer unit comprising the transfer belt according to claim 7 and a plurality of rollers rotatably supporting the transfer belt, the rollers including at least one roller disposed in contact with the region of the meander control member having a friction coefficient of about 0.5 to about 0.7 to control the lateral movement of the transfer belt, the transfer unit transferring the toner image from the surface of the electrophotographic photoreceptor to a surface of a recording medium via the transfer belt.
